(19) United States
(12) Patent Application Publication
(10) Pub. No.: US 2015/0224854 A1
(43) Pub. Date: Aug. 13, 2015

(54) Apparatus for Adjusting the Humidity in an at Least Partially Enclosed Interior Zone, Arrangement for Performing Ageing Tests on Products, and Method for Artificially Humidifying a Test Chamber Exposed to the Weather

(71) Applicant: Hans-Willi MÜLLER, Korschen (DE)

(72) Inventor: Hans-Willi Muller, Korschenbroich (DE)

(21) Appl. No.: 14/423,482

(22) PCT Filed: Aug. 26, 2013
(86) PCT No.: PCT/EP2013/002566

§ 371 Date: Feb. 24, 2015

(30) Foreign Application Priority Data
Aug. 24, 2012 (DE) 20 2012 008 059.8

(51) Int. Cl. B60H 3/02; G01N 17/00

(52) U.S. Cl. CPC B60H 3/02; G01N 17/002; B60H 2003/026

(57) ABSTRACT

The invention relates to an apparatus for adjusting the humidity in an at least partially enclosed interior zone such as an interior of a motor vehicle or the like, comprising a device for introducing humid air into the interior zone through an air duct system until a desired humidity value has been reached in the interior zone. The invention relates to an arrangement for performing ageing tests on products exposed to natural weather conditions as well as to a method for artificially humidifying a test chamber exposed to the weather.

### FIELD OF THE INVENTION

The invention relates to an apparatus for adjusting the humidity in an at least partially enclosed interior zone, to an arrangement for performing ageing tests on products, and to a method for artificially humidifying a test chamber exposed to weathering according to the preambles of claims 1, 6 and 7, respectively.

### TECHNICAL BACKGROUND

In the automobile industry, damage caused by material ageing is expected in a vehicle after a period of approximately 6-8 years. To this extent, improvements would only ever be introduced into the next-but-one development generation.

There is therefore a dependence on time-lapse tests, by which, in the most favorable case, causes of damage can even be discovered and eliminated before the commencement of production. At the same time, there is a wish to avoid causes of damage that would not even occur in practice from being caused by excessively severe testing conditions. Outdoor weathering is a possible means of testing by which developments and investigative approval tests can be carried out both in a time-lapse manner and also on the basis of real-life conditions.

In the automobile industry, the following correlation is used as a starting point (based on the climatic characteristics of dry-arid (Arizona/Kalahari) or moist-warm (Florida/KwaZulu-Natal):
1 year of outdoor weathering corresponds approximately to:
   3-4 years in southern Europe
   6-8 years in central Europe

The following requirements are derived from this:
1 year of outdoor weathering without the test object undergoing a change
2-3 years without losses of function

In the area of conflicting priorities between quality assurance and cost optimization, the pressure on developers is not becoming any less. The desire for a product to have a lifetime tailored to requirements is unfortunately still more likely to be fulfilled by iteratively empirical means than purely simulating calculations. This will also continue in the future to fuel the desire for methods of testing that, with even faster time lapse, provide a minimum level of certainty with respect to likely failures.

The growth of markets in the Asian region in particular has had the effect that, in addition to the previously customary climates, the tropical climate is playing a more important role in vehicle development than was the case in the past. Causes of damage that have not so far occurred in the subtropical or arid regions occur in practice in these tropical conditions.

At present, the automobile industry is predominantly using the high levels of radiation and heat of the desert climate (Arizona/Kalahari) and the subtropically warm and moist conditions such as occur in Florida or KwaZulu-Natal to achieve results in a time-lapse manner. This means that at least two vehicles have to be taken to these regions and regularly inspected and assessed by the technicians of the manufacturing companies. So a third location in a tropical zone, such as for example Malaysia, would be added.

For time-lapse ageing, it is thus important to obtain the highest possible solar irradiation, combined with a high temperature and corresponding humidity.

A technique for outdoor weathering is already known from EP-A-2 180 308 A1, in which the air surrounding the product to be tested is humidified. DE-A1-10 2009 012 259 discloses a method for testing a motor vehicle for its corrosion resistance in which the motor vehicle is placed in a climatic chamber after contact with a salt solution. An apparatus for creating salt mists for a salt testing chamber is known from DE-A1-100 10 250.

### SUMMARY OF THE INVENTION

Against this background, the invention is based on the object of providing an apparatus for adjusting the humidity in an at least partially enclosed interior zone, an arrangement for performing ageing tests on products and a method for artificially humidifying a test chamber exposed to weathering according to the preambles of claims 1, 6 and 7, respectively, by which the humidities of various climatic zones can be created in one location inexpensively, exactly and with a specifically intended effect directly on material to be tested, whereby the logistical costs and operating costs for the testing are reduced considerably.

This object is achieved according to the features of claims 1, 6 and 7, respectively.

This achieves the effect of providing an apparatus for adjusting the humidity in an at least partially enclosed interior zone such as an interior of a motor vehicle or the like in which there is provided a device for introducing humid air into the interior zone through an air duct system until a desired humidity value is reached in the interior zone.

The invention serves for optimizing ageing tests on products that are exposed to natural weathering, both directly (outdoors) and inside an enclosure (indoors), though it is not restricted to natural weathering but can also be advantageously used in the case of artificial weathering. The most graphic example is provided by the automobile industry, although the invention can be used for any products desired. The product itself may define the interior zone or be arranged in a test chamber that forms the interior zone. The interior zone is expediently completely enclosed, but may possibly have sizeable openings, such as gaps, ventilation openings, windows, etc.

The humidity is expediently adjusted by a predefined amount of water being introduced intermittently into the interior zone by means of the humid air and/or the humidified air until the desired humidity value is reached. In addition or as an alternative to this, humid air may be extracted from the interior zone by way of the air duct system while dry air is at the same time fed in, dry air may be made to flow into the interior zone and/or an opening of the interior zone may be actuated in a controlled manner. In this way, a quick and sufficiently exact adjustment or control of the humidity is possible, possibly over lengthy or very long time periods.

In particular in the case of motor vehicles, the air duct system may be connectable to an existing air duct system of the interior zone, in particular a ventilation or air-conditioning system of a motor vehicle, and/or be insertable into an opening of the interior zone, in particular a window gap of a motor vehicle.

Preferably, a sensor for measuring the humidity in the interior zone is provided, and the introduction and possibly discharge of humid and/or dry air and possibly opening of the interior zone for adjusting and/or maintaining the humidity can be controlled to a desired value in a manner dependent on the actual value.

The invention also provides an arrangement for performing ageing tests on products, which are exposed to natural weathering, comprising the product and an apparatus according to the invention for adjusting the humidity in an at least partially enclosed interior zone of the product.

Finally, the invention provides a method for artificially humidifying a test chamber exposed to weathering, in particular outdoor weathering, by introducing humid air into the test chamber through an air duct system until a desired humidity value is reached in the test chamber or a region thereof.

A test chamber or test enclosure (vehicle, solar box, or the like) is put out in a selected region and fitted with a system for humidifying the interior.

The humidification can be controlled on the basis of measuring and control technology, i.e., depending on the relative humidity measured, humidity is introduced into the interior of the enclosure by way of a feeding system until a desired value is reached. If the desired value is exceeded, the air in the interior is dehumidified again until the desired value is reached.

Further features and embodiments of the invention emerge from the description that follows, the figures and the claims.

### BRIEF DESCRIPTION OF THE FIGURES

FIGS. 1 to 5 show aspects of the invention.

### DETAILED DESCRIPTION OF EXEMPLARY EMBODIMENTS

Creation of the Humid Air

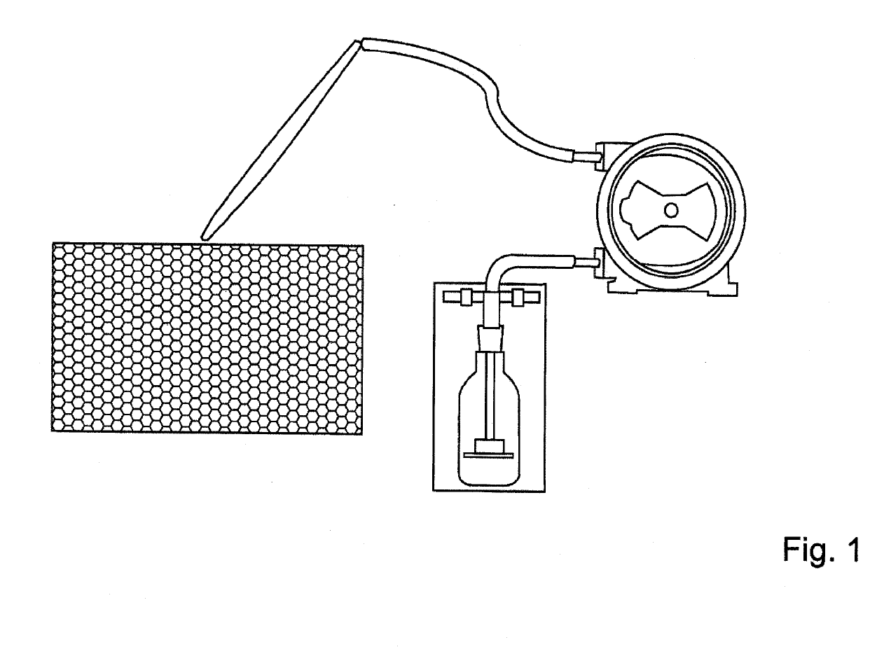

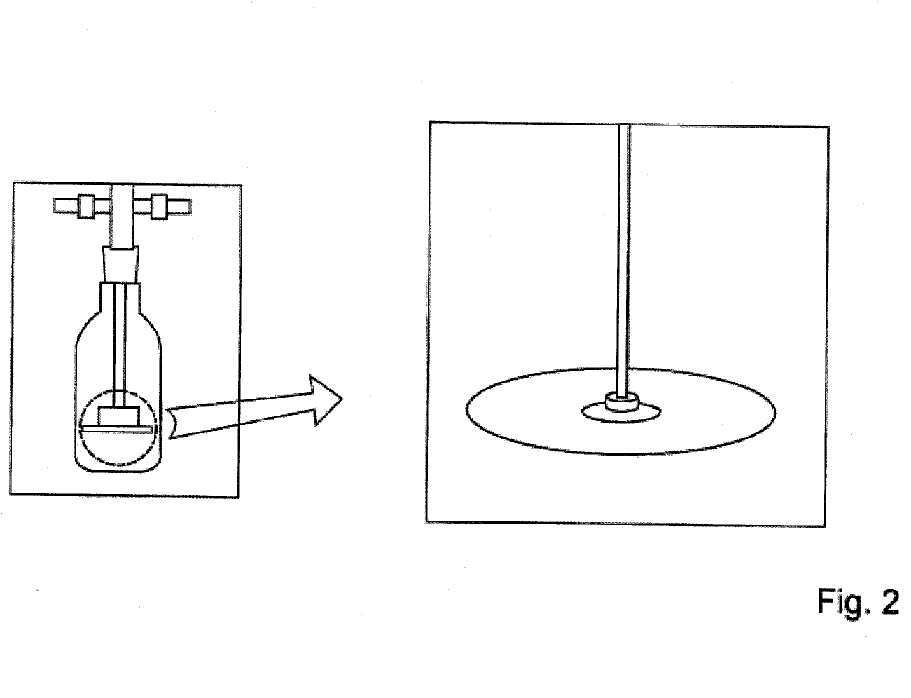

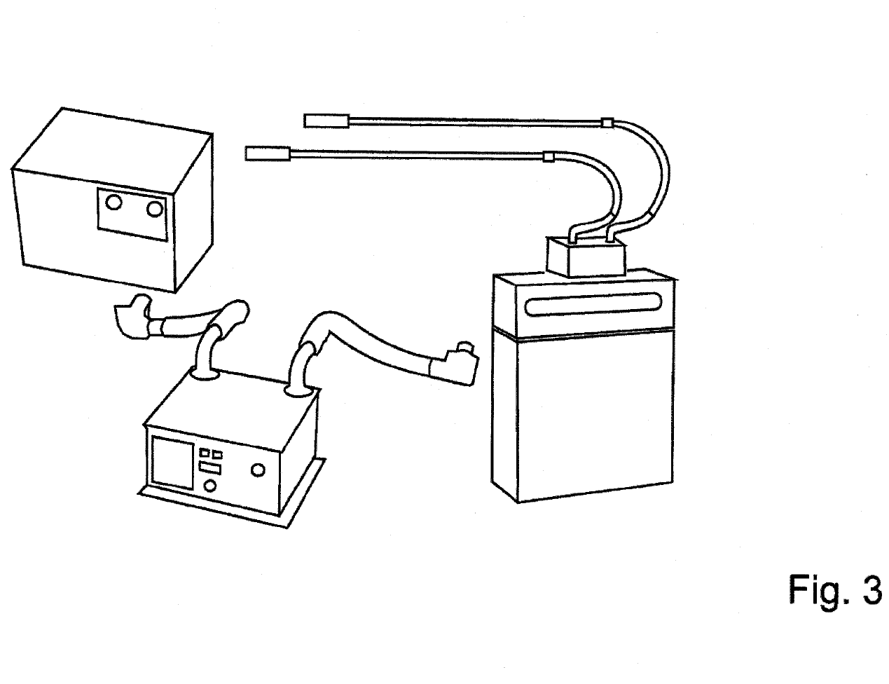

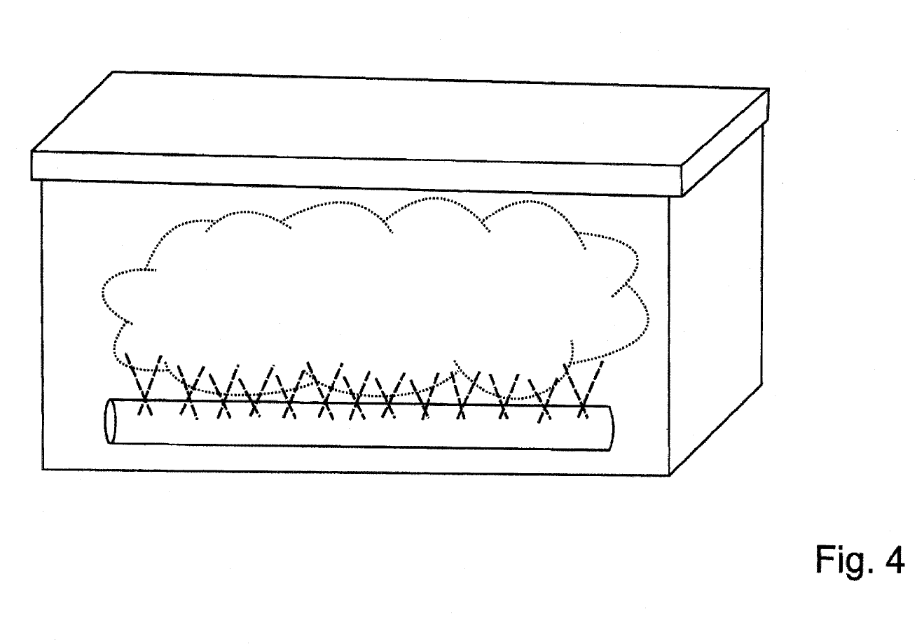

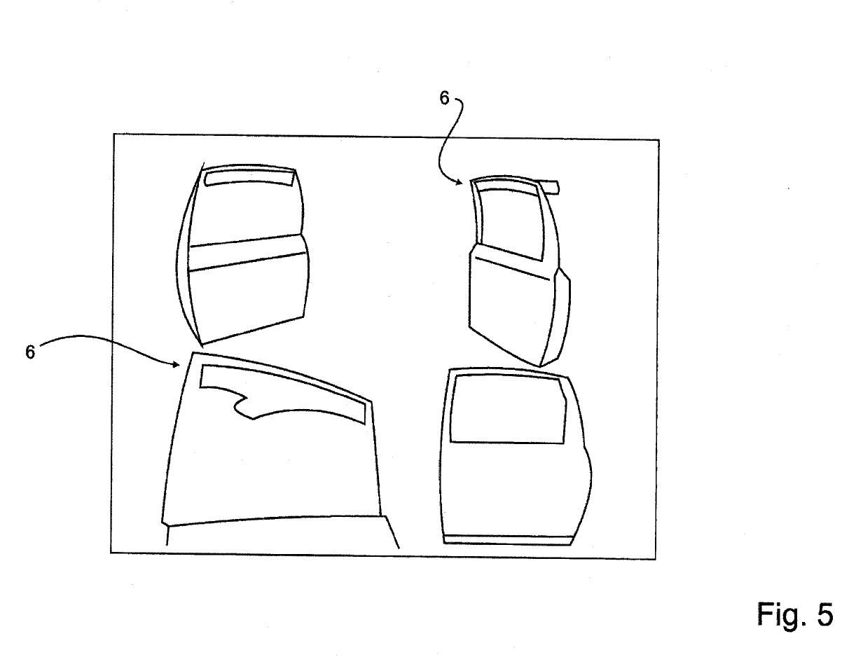

The creation of humid air can be performed on the basis of the following principles:
1. Metering onto a textile/filter: see FIG. 1
2. Enrichment of a stream of air:
   e.g. with a gas-washing bottle system, see FIG. 2
3. Ultrasonic atomizer: use of commercially available equipment, see FIG. 3
4. Steam humidifier: use of commercially available equipment
5. In the case of a simple testing box, by spraying the inside walls: see FIG. 4

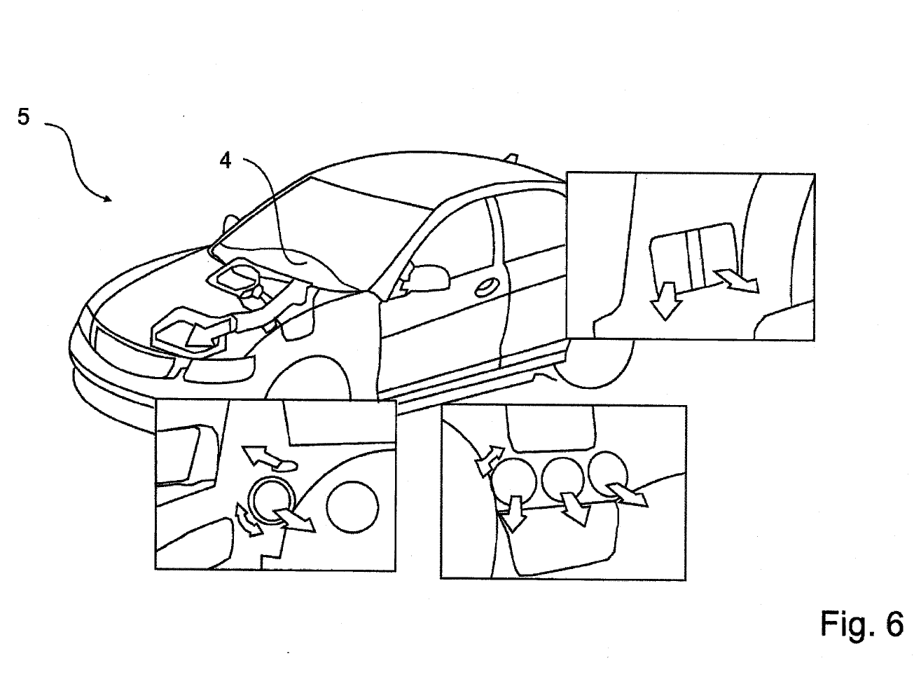

Introduction of the Humidified Air Into the Test Enclosure:
1. By simple inflow by way of air duct systems. For example by way of the window with a corresponding insert, see FIG. 5
2. By using an existing air duct system (ventilation, air-conditioning system), see FIG. 6

Discharge of the Humid Air
1. By reversal of the volumetric flow of the feeding system while at the same time feeding in dry fresh air
2. By introducing dry air by way of the humidifying system and displacing the humid air
3. By controlled opening of the enclosure, for example activation of the electric window lifters in the case of a vehicle

Controlling the Humidification

The humidifying equipment provides a metered amount of the water for humidification in accordance with the relative humidity measured in the enclosure. This means that either a calculated amount of water is introduced into the vehicle or humid air is introduced by switching the humidifier on and off until the desired value is reached.

1. An apparatus for adjusting the humidity in an at least partially enclosed interior zone such as an interior of a motor vehicle or the like, characterized by a device for introducing humid air into the interior zone through an air duct system until a desired humidity value is reached in the interior zone.

2. The apparatus as claimed in claim 1, characterized in that a predefined amount of water can be introduced intermittently into the interior zone by means of the humid air and/or the humidified air until the desired humidity value is reached.

3. The apparatus as claimed in claim 1, characterized in that humid air can be extracted from the interior zone by way of the air duct system while dry air is at the same time fed in, dry air can be made to flow into the interior zone and/or an opening of the interior zone can be actuated in a controlled manner.

4. The apparatus as claimed in claim 1, characterized in that the air duct system is connectable to an existing air duct system of the interior zone, in particular a ventilation or air-conditioning system of a motor vehicle, and/or is insertable into an opening of the interior zone, in particular a window gap of a motor vehicle.

5. The apparatus as claimed in claim 1, characterized in that a sensor for measuring the humidity in the interior zone is provided, and the introduction and possibly discharge of humid and/or dry air and possibly opening of the interior zone for adjusting and/or maintaining the humidity can be controlled.

6. An arrangement for performing ageing tests on products that are exposed to natural weathering, comprising the product, characterized by an apparatus as claimed in claim 1 for adjusting the humidity in an at least partially enclosed interior zone of the product.

7. A method for artificially humidifying a test chamber exposed to weathering, in particular outdoor weathering, characterized by introducing humid air into the test chamber through an air duct system until a desired humidity value is reached in the test chamber or a region thereof.

8. The apparatus as claimed in claim 2, characterized in that humid air can be extracted from the interior zone by way of the air duct system while dry air is at the same time fed in, dry air can be made to flow into the interior zone and/or an opening of the interior zone can be actuated in a controlled manner.

9. The apparatus as claimed in claim 8, characterized in that the air duct system is connectable to an existing air duct system of the interior zone, in particular a ventilation or air-conditioning system of a motor vehicle, and/or is insertable into an opening of the interior zone, in particular a window gap of a motor vehicle.

10. The apparatus as claimed in claim 9, characterized in that a sensor for measuring the humidity in the interior zone is provided, and the introduction and possibly discharge of humid and/or dry air and possibly opening of the interior zone for adjusting and/or maintaining the humidity can be controlled.

11. An arrangement for performing ageing tests on products that are exposed to natural weathering, comprising the product, characterized by an apparatus as claimed in claim 10 for adjusting the humidity in an at least partially enclosed interior zone of the product.
